(19) United States
(12) Patent Application Publication
(10) Pub. No.: US 2014/0215811 A1
(43) Pub. Date: Aug. 7, 2014

(54) LED PRESSURE-INSTALLING STRUCTURE

(71) Applicant: Foshan KonFonYon Technology Co., Ltd., Foshan City (CN)

(72) Inventor: Xinli YU, Foshan City (CN)

(73) Assignee: Foshan KonFonYon Technology Co., Ltd., Foshan City (CN)

(21) Appl. No.: 14/160,247

(22) Filed: Jan. 21, 2014

(30) Foreign Application Priority Data
Feb. 6, 2013 (CN) 201310048103.0

(51) Int. Cl. F21V 29/00

(52) U.S. Cl. CPC F21V 29/002
USPC 29/729

(57) ABSTRACT

The present invention discloses an LED pressure-installing structure, which comprises a radiator and an LED, and further comprises a pressure device for applying pressure on the LED to make it fit closely with the radiator. The present invention uses the pressure device to apply pressure on the LED to make it fit closely with the radiator, so a good heat transfer relationship between the LED and the radiator may be maintained without using a welding means, the whole heat dissipation effect of an LED light is increased, phenomena of loosening, dropping, and burning-out of the LED due to its unreliable installation are avoided, and the service life is prolonged. The present invention can be used for the manufacturing and assembling of the LED light.

### CROSS REFERENCE TO RELATED APPLICATIONS

The present application claims priority under 35 USC 119 to Chinese Patent Application No. 201310048103.0, filed 6 Feb. 2013, the contents of which are incorporated herein by reference.

### FIELD OF THE INVENTION

The present invention relates to an installing structure for an LED.

### BACKGROUND

For LED lights in the present market, most of the installing structures for their LED employ the means of welding the LED directly on an aluminum base circuit board. The firm level of installing the LED is increased and the heat can be dissipated by the aluminum substrate, but the welding point may often loosen due to the operating temperature, resulting in that the LED cannot closely contact the radiator, and the heat of the LED cannot be conducted out effectively, so the service life of the LED would be significantly reduced or the LED would be burned out. In another installing structure, a thermal pad is disposed under the LED itself, and bonded with the radiator. The heat produced when the LED is operating is transferred to the radiator through the thermal pad, and the radiator is responsible for dissipating heat for the LED. However, this installing structure cannot ensure that the thermal pad of the LED may closely contact the radiator all the time. When the two loosen, an air heat insulating layer is created between them, which goes against transferring and dissipating the heat in time. Even if in the prior art, a layer of thermal adhesive is applied between the thermal pad and the radiator in attempt to ensure the heat transfer, the thermal adhesive would lose efficacy after a long time of use.

### SUMMARY

The technical problem to be solved by the present invention is: to provide an LED pressure-installing structure, which may stably maintain the heat transfer relationship between the LED and the radiator for a long time, ensure the heat dissipation effect, and prevent the burning-out, without welding the LED on the circuit board.

The solution to the technical problem of the present invention is an LED pressure-installing structure, comprising a radiator and an LED, and further comprising a pressure device for applying pressure on the LED to make the LED fit closely with the radiator.

As a further improvement of the above technical solution, the LED comprises a lamp body and a thermal pad coupled with the lamp body, and the pressure device contacts the lamp body and applies pressure to make the thermal pad fit closely with the radiator.

As a further improvement of the above technical solution, the pressure device comprises a pressure sheet, which contacts the periphery of the LED and has a hole or notch disposed thereon for exposing the LED, and the pressure sheet is coupled with the radiator and fixed.

The beneficial effect of the present invention is: the present invention uses the pressure device to apply pressure on the LED to make it fit closely with the radiator, so a good heat transfer relationship between the LED and the radiator may be maintained without using a welding means, the whole heat dissipation effect of an LED light is increased, phenomena of loosening, dropping, and burning-out of the LED due to its unreliable installation are avoided, and the service life is prolonged.

When the installing structure of the present invention is employed, the LED light may be assembled without using an aluminum base circuit board, so that the cost of production and subsequent maintenance may be reduced, there is no process of producing and machining the circuit board, the recycling is simple, and it is more environment friendly.

The present invention can be used for the manufacturing and assembling of the LED light.

### BRIEF DESCRIPTION OF THE DRAWINGS

To illustrate the technical solutions in the embodiments of the present invention more clearly, the drawings required to describe the embodiments will be illustrated simply hereinafter. It is obvious that the described drawings are merely a part of the embodiments of the present invention, rather than all the embodiments. Those skilled in the art may also obtain other design solutions and drawings according to these accompanying drawings without doing a creative work.

FIG. 1 is a schematic structural side view of an embodiment 1 of the present invention;

FIG. 2 is a top view of the embodiment 1;

FIG. 3 is a schematic structural side view of an embodiment 2;

FIG. 4 is a top view of the embodiment 2;

FIG. 5 is a schematic structural side view of an embodiment 3;

FIG. 6 is a schematic structural side view of an embodiment 4.

### DETAILED DESCRIPTION OF THE PREFERRED EMBODIMENTS

The concepts, specific structures, and resulted technical effects of the present invention will be described clearly and completely below in connection with the embodiments and the accompanying drawings, to provide a full understanding on the objects, features, and effects of the present invention. It is obvious that the described embodiments are merely a part of the embodiments of the present invention, rather than all the embodiments. Other embodiments obtained by those skilled in the art based on the embodiments of the present invention without doing a creative work fall within the scope protected by the present invention. Further, all the coupling/connecting relationships mentioned herein do not only refer to the direct connections of members, but also refer to those connections by adding or reducing the coupling accessories according to a specific implementation in order to make a better coupling structure.

An LED pressure-installing structure comprises a radiator 1 and an LED 2, and also comprises a pressure device for applying pressure on the LED 2 to make it fit closely with the radiator 1.

Further as a preferred embodiment, the LED 2 comprises a lamp body and a thermal pad 3 coupled with the lamp body, and the pressure device contacts the lamp body and applies pressure to make the thermal pad 3 fit closely with the radiator 1. The thermal pad is added to take away the heat of the LED better, to pass it to the radiator.

Further as a preferred embodiment, the pressure device comprises a pressure sheet 4, which contacts the periphery of the LED 2 and has a hole or notch disposed thereon for exposing the LED 2, and the pressure sheet 4 is coupled with the radiator 1 and fixed.

### Embodiment 1

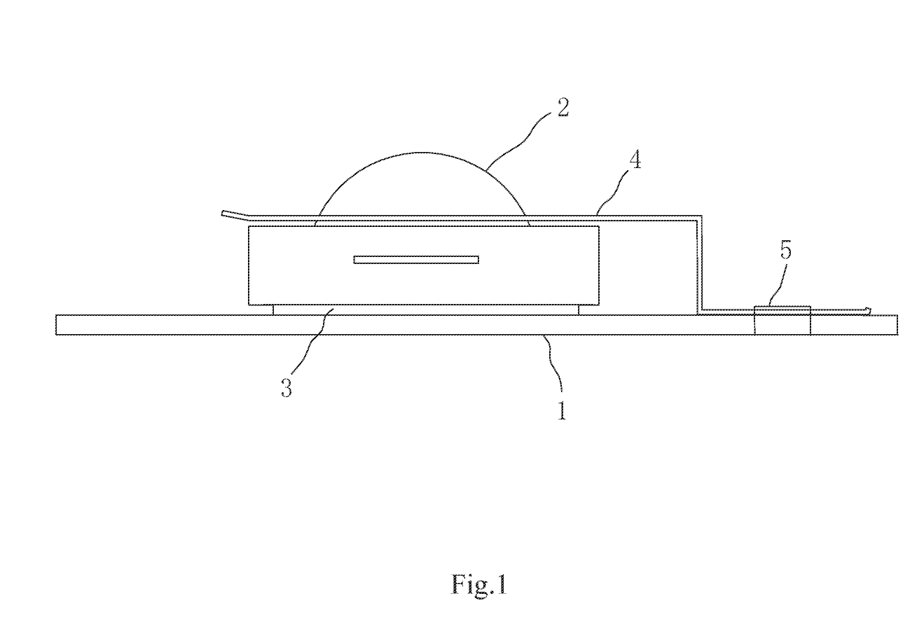

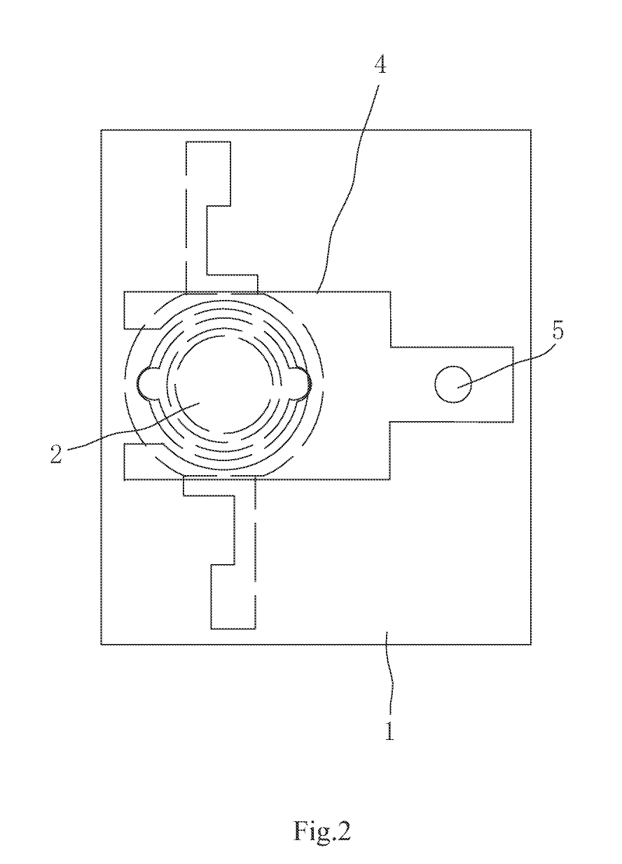

Referring to FIGS. 1 and 2, the pressure device also comprises a fastener 5, which is coupled with the radiator 1 and the pressure sheet 4 and maintains the trend that the pressure sheet 4 presses the LED 2 towards the radiator 1; the pressure sheet 4 is elastic, generally is of a “Z” shape, and has an upper segment contacting the periphery of the LED 2, a lower segment coupled with the radiator 1, and a middle segment connecting the upper segment with the lower segment; the lower segment of the pressure sheet 4 is secured to the radiator 1 by the fastener 5.

At this time, the pressure sheet 4 functions as a “spring sheet”, a lower segment of which is fixed to the radiator, and an upper segment of which is made into a depressed shape in advance. When it is mated with the LED, a downward pressure would be generated on the LED due to its elasticity, pressing the LED along with its thermal pad towards the radiator, so it ensures that the LED is fit closely with the radiator, preventing the loosening. To couple the pressure sheet 4 with the radiator 1, the fastener 5 may take the form of a buckle, a rivet, and so on. Because of this fixed end, the pressure sheet 4 can be pressed down, and the fastener 5 functions to maintain the trend that the pressure sheet 4 presses the LED 2 towards the radiator 1.

### Embodiment 2

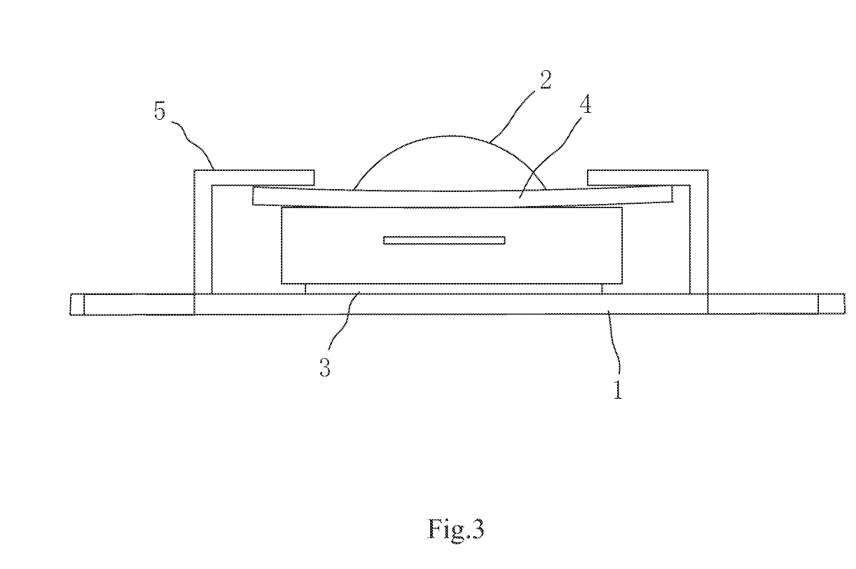

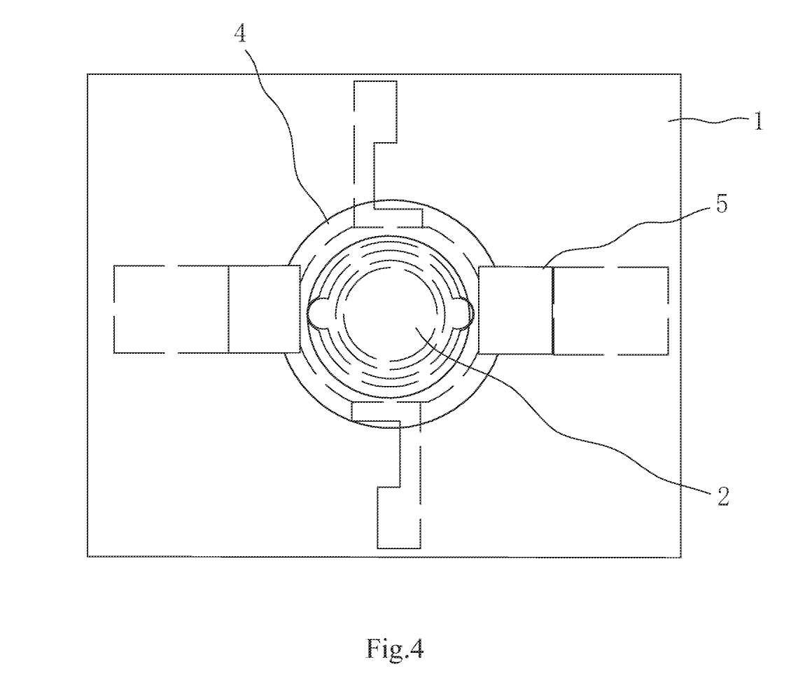

Referring to FIGS. 3 and 4, the pressure device also comprises a fastener 5, which is coupled with the radiator 1 and the pressure sheet 4 and maintains the trend that the pressure sheet 4 presses the LED 2 towards the radiator 1; the pressure sheet 4 generally is of an annular sheet shape, with an inner circle pressing against the periphery of the LED 2; the fastener 5 is elastic, generally is of a “7” shape, and has a lower end coupled with the radiator 1 and an upper segment coupled with or pressing against an outer circle of the pressure sheet 4; a plurality of fasteners 5 are arranged around the LED 2 to press against the pressure sheet 4 together.

To increase the rationality of the force orientation, an annular pressure sheet 4 and several (in general, 4) fasteners 5 surrounding it are specially designed. At this time, the fastener 5 functions as an “elastic buckle”, which presses down the pressure sheet 4 to press against the LED 2, so it may also ensure the bonding and tight pressing of the LED 2 and the radiator 1.

### Embodiment 3

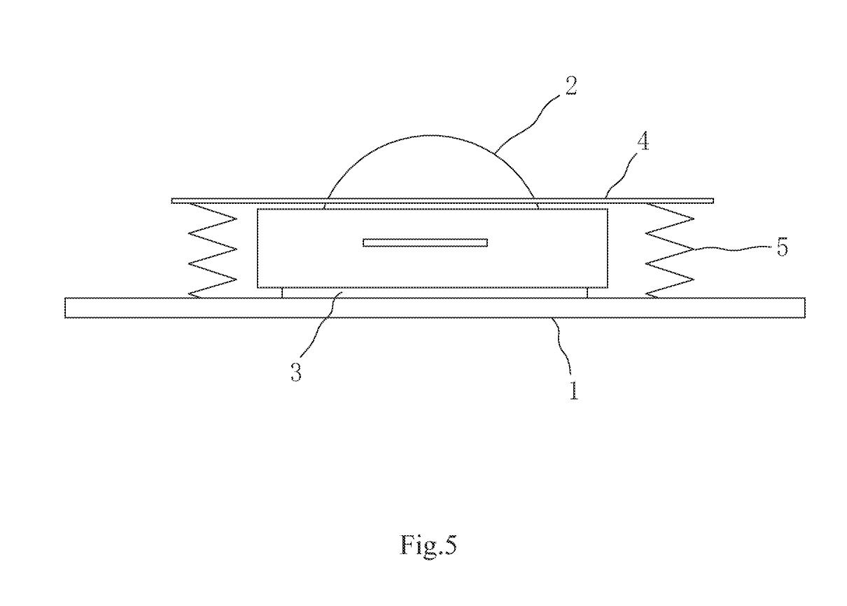

Referring to FIG. 5, a spring is employed as the fastener 5, two ends of which are coupled with the pressure sheet 4 and the radiator 1, respectively. In this way, it does not matter whether or not the pressure sheet 4 is elastic, because the spring may pull down the pressure sheet 4 to press against the LED.

### Embodiment 4

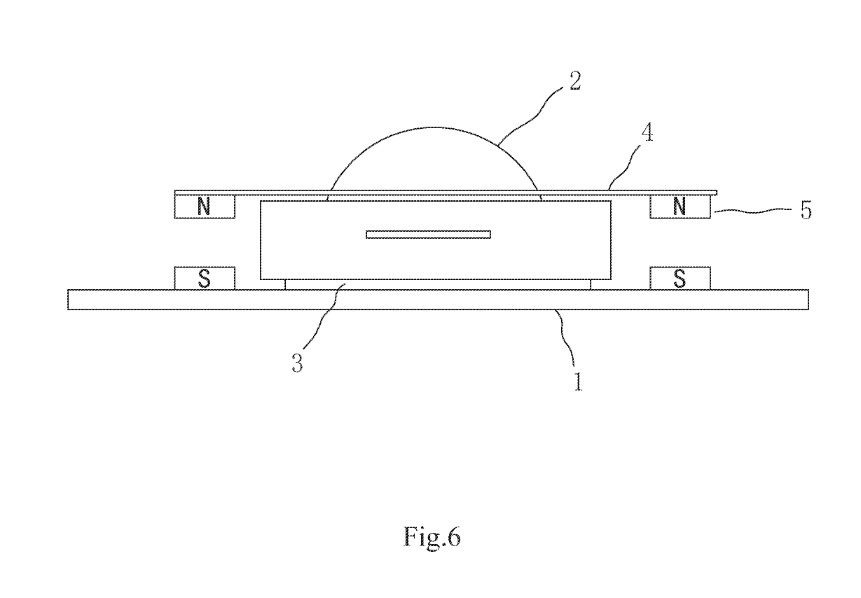

Referring to FIG. 6, a magnet set is employed as the fastener 5, which has two poles that attract each other, one installed on the pressure sheet 4, and the other installed on the radiator 1. The magnet set may be a permanent magnet or an electromagnet. Through the attractive power of the magnetic poles, the pressure sheet 4 may also generate a downward pressure to tightly press the LED.

The preferred embodiments of the present invention are illustrated specifically above, but the present invention is not limited to the embodiments. Those skilled in the art may also make various equivalent variations or substitutions without departing from the spirit of the present invention, and these equivalent variations or substitutions are all encompassed within the scope defined by the claims.

What is claimed is:

1. An LED pressure-installing structure comprising a radiator (1) and an LED (2), and further comprising a pressure device for applying pressure on the LED (2) to make the LED (2) fit closely with the radiator (1).

2. The LED pressure-installing structure of claim 1, wherein the LED (2) comprises a lamp body and a thermal pad (3) coupled with the lamp body, and the pressure device contacts the lamp body and applies pressure to make the thermal pad (3) fit closely with the radiator (1).

3. The LED pressure-installing structure of claim 1, wherein the pressure device comprises a pressure sheet (4), which contacts the periphery of the LED (2) and has a hole or notch disposed thereon for exposing the LED (2), and wherein the pressure sheet (4) is coupled with the radiator (1) and fixed.

4. The LED pressure-installing structure of claim 3, wherein the pressure device further comprises a fastener (5), which is coupled with the radiator (1) and the pressure sheet (4) and maintains the trend that the pressure sheet (4) presses the LED (2) towards the radiator (1).

5. The LED pressure-installing structure of claim 4, wherein the pressure sheet (4) is elastic, generally of a “Z” shape, and has an upper segment contacting the periphery of the LED (2), a lower segment coupled with the radiator (1), and a middle segment connecting the upper segment with the lower segment, and wherein the lower segment of the pressure sheet (4) is secured to the radiator (1) by the fastener (5).

6. The LED pressure-installing structure of claim 3, wherein the pressure sheet (4) is generally annular, with an inner circle pressing against the periphery of the LED (2), and wherein the fastener (5) is elastic, generally is of a “7” shape, and has a lower end coupled with the radiator (1) and an upper segment coupled with or pressing against an outer circle of the pressure sheet (4).

7. The LED pressure-installing structure of claim 6, wherein a plurality of fasteners (5) are arranged around the LED (2) to press against the pressure sheet (4) together.

8. The LED pressure-installing structure of claim 4, wherein the fastener (5) is a spring, two ends of which are coupled with the pressure sheet (4) and the radiator (1), respectively.

9. The LED pressure-installing structure of claim 4, wherein the fastener (5) is a magnet set, which has two poles that attract each other, one installed on the pressure sheet (4), and the other installed on the radiator (1).
